(19) United States
(12) Patent Application Publication
(10) Pub. No.: US 2002/0194283 A1
(43) Pub. Date: Dec. 19, 2002

(54) Method of transmitting information using computer systems

(76) Inventors: Christopher Michael Rose, (US); Mukesh Mohanbhai, (US)

Correspondence Address: MASON, MASON & ALBRIGHT, 2306 South Eads Street, P.O. Box 2246, Arlington, VA, 22202, US

(21) Appl. No.: 10/090,733

(22) Filed: Mar. 6, 2002

(30) Foreign Application Priority Data
Mar. 7, 2001 (NZ) NZ510,389

(51) Int. Cl. G06F 15/16

(52) U.S. Cl. 709/206

(57) ABSTRACT

The present invention relates to a method of transmitting information using computer systems loaded with appropriate software. Such software may allow a method of transmitting information through executing a series of steps, starting with the software receiving intended recipient information from a sender of information, and in turn also receiving details from a sender of a storage location within the sender's computer system at which information to be transmitted is stored. Such software can then transmit all the information stored within the sender's computer system at the storage location detailed to an intended recipient or recipient for such information.

### TECHNICAL FIELD

This invention relates to a method of transmitting information using computer systems. Specifically the present invention may be adapted to allow information coded into computer files to be sent using electronic mail (e-mail) transmission protocols. Reference throughout the specification will also be made to the present invention being used to facilitate e-mail transmissions. However, those skilled in the art should appreciate that other types of data transmission schemes may be used with the present invention, and reference to the above only throughout the specification should in no way be seen as limiting.

### BACKGROUND ART

Computer systems and personal computers are widely used to transmit and disseminate information. With the development of the Internet, a large number of people are now using computer systems to share and publish information.

One popular computer based communication method is electronic mail or e-mail. An e-mail may be defined as any information transmission which uses one of a number of specific computer communication protocols, such as for example SMTP, IMAP or POP protocols.

E-mails are widely used to send short text notes or documents between users. However there are some limitations associated with known types of e-mail software or applications. As it is not the main function of such software to allow the transmission of non-text based computer files, existing software applications require the user to execute a number of steps or operations to attach or forward a non-text file via e-mail. This can significantly slow down and complicate an e-mail transmission, and for those with limited experience with computers this can be a daunting task.

A method of transmitting information using computer systems that solve any or all the above problems would be of advantage. Specifically a method and software application which used e-mail transmissions protocols and which provided an easy to use interface for the user would be of advantage. A method of transmitting information which allowed a sender to replicate the contents of a folder or directory on the sender's computer system within a recipient's computer system would also be of advantage.

It is an object of the present invention to address the foregoing problems or at least to provide the public with a useful choice.

Further aspects and advantages of the present invention will become apparent from the ensuing description that is given by way of example only.

### DISCLOSURE OF INVENTION

According to one aspect of the present invention, there is provided a method of transmitting information using a computer system loaded with software adapted to execute the steps of;

(i) receiving intended recipient information from a sender of information, and

(ii) receiving details from the sender of a storage location within a senders computer system at which information to be transmitted is stored, and

(iii) transmitting all information stored within the sender's computer system at the storage location detailed by the sender to the intended recipient or recipients.

According to a further aspect of the present invention there is provided a method substantially as described above wherein a storage location consists of a directory or folder within the sender's computer system that is configured to contain at least one computer file.

According to a further aspect of the present invention there is provided a method of transmitting information using a computer system loaded with software executing the steps of;

(i) receiving intended recipient information from a sender of information, and receiving details from the sender of a storage location within a senders computer system at which information to be transmitted is stored, and

(ii) receiving destination information from the sender indicating where the information to be transmitted is to be stored within a recipients computer system, and

(iii) transmitting all information stored within the sender's computer system at the storage location detailed by the sender to the intended recipient or recipients.

According to yet another aspect of the present invention, there is provided a method of transmitting information substantially as described above, further characterised by the subsequent step of

(iv) replicating the contents of the storage location within the sender's computer in a destination location within the recipients computer system associated with the destination information specified by the sender.

According to a further aspect of the present invention there is provided a method of receiving information using software loaded onto a computer system, characterised by the steps of:

(i) receiving an electronic information transmission where the information transmitted includes destination information, and

(ii) storing the content of said information transmission in a destination location identified by the destination information.

According to another aspect of the present invention there is provided a computer system programmed with computer software adapted to perform the method of transmitting information substantially as described above.

According to a further aspect of the present invention there is provided computer software adapted to perform the method of transmitting information substantially as described above.

The present invention is adapted to facilitate a method of transmitting information using computer systems. Those skilled in the art should appreciate that a computer or a computer system may be formed from any programmable logic device or processing element ranging in size from small micro-processors to personal computers or work stations, up to large scale main frame computers. Reference throughout the specification will now be made to computer systems used in conjunction with the present invention being personal computers or workstations. However, those skilled in the art should appreciate that this should in no way be seen as limiting.

Reference throughout the specification will also be made to the transmission of information using such computer systems being completed using electronic mail or e-mail transmission protocols. Those skilled in the art should appreciate that reference to information being “emailed” should not be seen as limiting, and the present invention may also use any known electronic information transmission scheme or set of protocols.

For example, in one alternative embodiment information may be transmitted using file transfer protocol (FTP), hypertext transfer protocol (HTTP), or any other known type of transmission protocol for computer systems. FTP, HTTP, or other transmission protocols may also be employed in conjunction with the present invention if required.

The present invention may be adapted to allow the transmission of information between senders and recipients. Senders and recipients may be defined as any individuals, organisations or groups that have the need to either send or receive information using computer systems. Those skilled in the art should also appreciate that the present invention may be extended to allow a single sender in one operation to transmit multiple copies of computer files to multiple recipients, or to just a single recipient if required.

Preferably the present invention may incorporate or be associated with computer software adapted to facilitate the transmission of information through computer systems. Computer software may be written and copied on to the computer systems of senders and recipients to facilitate the communication of information stored in an electronic format.

Reference throughout the specification will also be made to such transmission software executing all steps involved with the method discussed below. Those skilled in the art should appreciate that to facilitate such a method multiple copies of the same software may be loaded on to users computer systems to communicate with each other and to allow for the effective transmission of information. However, it should also be appreciated that in some instances a single copy only of said software may be designed to facilitate the method of the present invention if required.

Preferably as a first step of the method executed a sender may supply the software used in accordance with the present invention with intended recipient information. Intended recipient information provides details of the identities or potentially the locations of recipients for the information to be transmitted. This recipient information may take a number of different forms, from simply the name of the recipient, or an alias for the recipient to alternatively an email or Internet address for the recipient.

In a further preferred embodiment intended recipient information can consist of or include an internet address, email address and/or location information for an intended recipient. However, in alternative embodiments intended recipient information may simply include a name or alias for an intended recipient. Further information stored on a sender's computer system may then be matched to the name or alias provided to facilitate the transmission of information required.

Those skilled in the art should appreciate that recipient information may be defined as any information which indicates to whom or to which recipient computer system information is to be transmitted. Reference throughout this specification will also be made to intended recipient information being an email address for an intended recipient. However, alternatives to this case may also be used.

Preferably a sender of information may also supply the transmission software used with details of a storage location within the sender's computer system within which information to be transmitted is stored. Such a storage location information may provide the software involved with a reference or path to the information to be transmitted.

A storage location may be formed from or be included within any type of electronic information storage media, or a portion thereof. A storage location may form a portion or region of the storage capacity of such media which may be constructed from, for example, hard disks integrated into the computer system, separate floppy disks or optical media such as standard CD's or DVD's.

Those skilled in the art should appreciate that any form of data storage media which may be interfaced with a computer system may be used in conjunction with the present invention. For example, in one alternative embodiment a storage location may consist of a port (for example, a coms, serial or parallel port) in the computer system to which the information received can be transmitted. Such a port can be linked to other computer hardware which in turn may be defined as forming or incorporating a destination location for the transmitted information.

Reference throughout this specification will be made to a storage location being stored or located within the sender or recipient's computer system. Preferably the storage location involved may be located on the hard disk or hard drive of such computer systems but again those skilled in the art should appreciate that alternatives to this case are also envisioned.

In a further preferred embodiment the storage location which is detailed by the sender may be a directory or folder stored within the sender's computer system. This feature of the invention provides an intuitive interface for a sender of information, as they simply need to indicate to the transmission software which of their directories or folders are to have their contents transmitted. Simply by indicating a folder or directory as the storage location a sender can instigate the transmission of many separate computer files with a minimal number of commands or actions.

Reference throughout this specification will also be made to a storage location being a directory or folder structure stored within a hard drive of incorporated information into the sender's computer system. However, those skilled in the art should appreciate that the storage location may be any type of data structure or element that can hold a collection of computer files or software objects.

In a preferred embodiment the transmission software used in accordance with the present invention may also receive details from a sender indicating where the information transmitted is to be stored within a recipient's computer system. The information supplied may be described as destination information that is used when the transmission involved is received by a recipient.

Destination information may take many different forms depending on the particular implementation of the present invention. For example, in some instances destination information may be an explicit path or directory name within a hard drive of the recipient's computer system where the information is to be saved. Alternatively destination information may consist of a label or an alias tag which provides an indication to the recipient as to the nature of the information transmitted. From this tag or alias the recipient's own computer system may then act on instructions provided by a recipient as to the storage location within the recipient's computer system at which the transmitted information should be saved to.

In a preferred embodiment once the information to be transmitted has been received by the recipient, the information transmitted may be saved in the storage location detailed by the sender to overwrite existing content within the nominated storage or destination location. In some instances the contents of the memory area which the information transmitted is to be saved with automatically be deleted, and then the information transmitted will be saved to that storage location. With this operation the sender can be sure that the contents of the storage location they originally indicated on their own computer system is replicated within the recipient's computer system. This feature of the invention may be used by senders to ensure that through transmissions they can synchronise the content of folders or directories also accessed by recipients.

However, in an alternative embodiment the entire contents of the destination location identified may not necessarily be overwritten before the transmitted information is stored. For example, in one alternative embodiment only computer files originally stored within the destination location which have the same name and/or attributes as received transmission files may be overwritten.

In a further preferred embodiment the replication functions discussed above may be further extended to provide a two way mirroring of all files stored in the storage locations involved. In such instances the transmission software may also be used to replicate the contents of the recipient's folder within an associated folder on a sender's machine. In such instances if the recipient makes changes or amendments to the computer files transmitted and still stored within the recipient's destination folder or directory, these changes will also be mirrored within the associated folder stored in the sender's computer system.

The present invention allows information to be transmitted by the computer software executing a number of steps.

Firstly the prospective sender of information will compile a folder or director of computer files which they wish to transmit. Next the sender will identify the folder or directory prepared to the transmission software used for the present invention. At this stage the sender will also supply the software with recipient information in the form of email addresses for each recipient of the contents of the folder.

As an additional but potentially optional step the sender may also provide location information for the transmission to be made to each recipient. This location information may indicate a directory or folder name within the recipient's computer system which the files to be transmitted are to be saved. Alternatively, location information may consist of a tag or alias which is used by the recipient to control the storage of the information transmitted.

With this information the transmission software used will then transmit the files within the sender's folder or directory to the recipients specified. The location information associated with each transmission may also be used to select the location on each recipient's computer system in which the transmitted files are to be saved.

Preferably when the transmitted files are saved on the recipient's computer system, the contents of the sender's original or source directory are replicated in a folder or directory on the recipient's computer system. To create the replica folder or directory the transmission software used will delete the existing contents of the folder and then replace it with the files transmitted by the sender. With this feature of the invention the sender can be sure of the contents of the folder which they indicated the transmitted files should be saved within on the recipient's computer system.

Preferably the transmission of such information or computer files may be via an e-mail transmission protocol. However, those skilled in the art should appreciate that other forms of electronic data transmission may also be used, and reference to the above only throughout the specification should in no way be seen as limiting.

The transmission of the information or computer files may also be controlled or timed depending on the sender's requirements and the capacity of their computer system. For example, in one embodiment computer files may be stored until a scheduled transmission time each day at which point they will be e-mailed on by the computer software loaded into the sender's computer system. In this way transmissions of information can be timed to suit transmission network traffic loads as transmissions may be made during “off peak” times of the day. Alternatively, in some embodiments the sender may configured their software to automatically and immediately e-mail on any files which instructions are given to transmit or when changes are made to the files involved by a sender. In this instance transmissions will be made when all of the information required by the software involved has been obtained. in yet another embodiment the sender may trigger the e-mailing of computer files by issuing a command to the computer software on their computer system.

In a further preferred embodiment of the present invention may also provide additional features or functions in addition to the basic method described above. In such instances sender identity information associated with the transmission may be used to trigger additional processes run on the intended recipient's computer system.

For example in one embodiment, when receiving an e-mailed computer document, the computer software may initially check the source or identity of the sender of the e-mail. The sender's identity can potentially be used to decode any security encryption present in the file e-mailed or to trigger execution of another application. Furthermore, in some embodiments the computer software may also copy or forward on automatically the computer file received to other software applications or other storage locations on the recipients computer system if required.

However, in alternative embodiments the additional processes executed may be run as entirely independent from one another. For example, a virus checker may be run irrespective of whether the sender's identity information is recognised Furthermore, the recipient's computer system may also be adapted to automatically forward or copy the transmission received to a further intended recipient. In yet another alternative embodiment an additional process executed run on the recipient's computer system can supply the received transmission to an algorithm running on the intended recipient's computer system as input to said algorithm.

The present invention may provide a substantially improved method by which computer files may be e-mailed between senders and recipients. The present invention may provide for the transmission of an entire folder or directory of computer files to a number of recipients both easily and quickly. The sender can simply nominate which folder is to have its contents transmitted and those files will be forwarded to the recipients they nominate.

The present invention may also be adapted to indicate to a recipient the location at which the information transmitted is to be stored. Either through an explicit path or reference system, or alternatively through an alias nomination system information may be provided to a recipient as to where the files transmitted are to be stored.

### BRIEF DESCRIPTION OF DRAWINGS

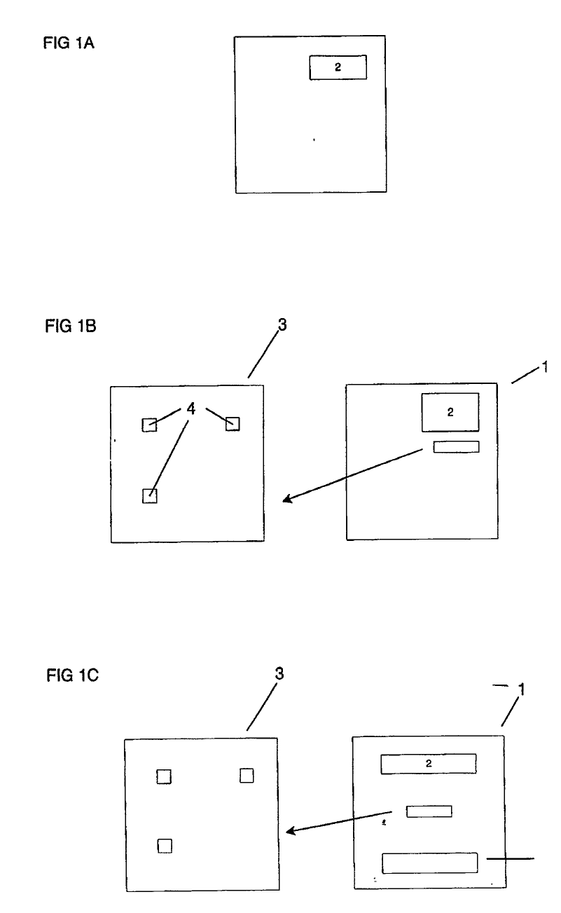

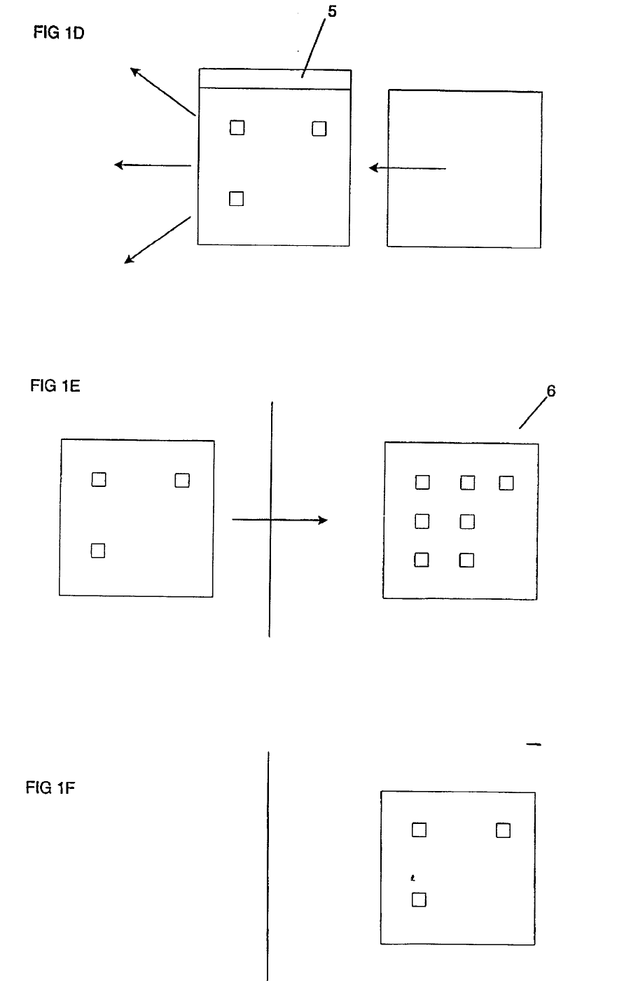

Further aspects of the present invention will become apparent from the following description that is given by way of example only and with reference to the accompanying drawings in which: FIGS. 1A to 1F: show block schematic diagrams of the steps executed and information transferred in accordance with the method of the present invention in a preferred embodiment.

### BEST MODES FOR CARRYING OUT THE INVENTION

FIGS. 1A to 1F shows block schematic diagrams of the steps executed and information transferred in accordance with the method of the present invention in a preferred embodiment.

In the steps shown with respect to FIG. 1A a potential sender of information supplies software 1 adapted to implement the present invention with intended recipient information. This information may be in the form of the email addresses of a number of recipients that the sender wishes to transmit information to.

The next step of this process is shown with respect to FIG. 1B where the sender of information provides the software 1 with details of a storage location 3 at which the information to be transmitted, (in this case computer files 4) are stored.

In the following step of this method the sender will then supply to the software 1 with destination information 5 which indicates where the computer files 4 to be transmitted are to be stored within a recipient's computer system.

Once all of the above information has been received by the software 1 the steps shown with respect to FIG. 1D will be executed. At this stage the files contained within the source folder or directory 3 of the sender will be transmitted out to each of the intended recipients nominated by the recipient information supplied by the sender in step FIG. 1A. Associated or tagged to each transmission will also be the destination information 5 supplied to the software by the sender.

The reception of this information is shown with respect to FIG. 1E where the destination information 5 is used to locate a destination folder or directory 6 within a recipient's computer system. The destination folder 6 may have some pre-existing computer files 4 already stored within it. However, on receipt of the sender's transmission this existing content will be deleted and then transmitted files from the sender will be stored in their place (shown with respect to FIG. 1F). This step will replicate the contents of the original or source folder 3 on the sender's computer system within the recipient's computer system in the destination folder 6 indicated by the original destination information 5 supplied by the sender.

Aspects of the present invention have been described by way of example only and it should be appreciated that modifications and additions may be made thereto without departing from the scope thereof.

The claims defining the invention are:

1. A method of transmitting information using a computer system loaded with software executing the steps of;
(i) receiving intended recipient information from a sender of information, and
(ii) receiving details from the sender of a storage location within the sender's computer system at which information to be transmitted is stored, and
(iii) transmitting all information stored within the sender's computer system at the storage location detailed by the sender to the intended recipient or recipients.

2. A method of transmitting information using a computer system loaded with software executing the steps of;
(i) receiving intended recipient information from a sender of the information, and
(ii) receiving details from the sender of a storage location within a sender's computer system at which information to be transmitted is stored, and
(iii) receiving destination information from the sender indicating where the information to be transmitted is to be stored within a recipient's computer system, and
(iv) transmitting all information stored within the sender's computer system at the storage location detailed by the sender to the intended recipient or recipients.

3. A method of transmitting information as claimed in claim 2, further characterised by the additional subsequent step of:
(v) replicating the contents of the storage location within the sender's computer in a destination location within the recipient's computer system associated with the destination information specified by the sender.

4. A method of transmitting information as claimed in claim 1 wherein email or electronic mail transmission protocols used to transmit information.

5. A method of transmitting information as claimed in claim 1 wherein HTTP transmission protocols are used to transmit information.

6. A method of transmitting information as claimed in any claim 1 wherein intended recipient information includes an internet address, email address and/or location information for intended recipients.

7. A method of transmitting information as claimed in claim 1 wherein intended recipient information includes a name or alias for an intended recipient.

8. A method of transmitting information as claimed in claim 1 wherein storage location information provides a reference or path to information to be transmitted.

9. A method of transmitting information as claimed in claim 1 wherein a storage location includes any type of electronic storage media or a portion thereof.

10. A method of transmitting information as claimed in claim 9 wherein a storage location is a directory formed within a hard drive incorporated into the sender's computer system.

11. A method of transmitting information as claimed in claim 9 wherein a storage location includes a port associated with a sender's computer system from which information to be transmitted can be extracted by the sender's computer system.

12. A method of transmitting information as claimed in claim 1 wherein destination information is used to determine where information to be transmitted is to be stored in a recipient's computer system.

13. A method of transmitting information as claimed in claim 12 wherein destination information includes details of an explicit path or directory within a hard drive of the recipient's computer system to which received information is to be saved.

14. A method of transmitting information as claimed in claim 12 wherein destination information includes an alias, name or tag indicating to the recipient the nature of the information transmitted.

15 A method of transmitting information as claimed in claim 1 wherein received information is stored within a destination location which overwrites the existing information of content of the destination location.

16. A method of transmitting information as claimed in claim 15 wherein the entire content of the destination location is deleted before the received information is stored within the destination location.

17. A method of transmitting information as claimed in claim 15 wherein only computer files originally stored within a destination location which have the same name and/or attributes as received transmission files are overwritten.

18. A method of transmitting information as claimed in claim 1 wherein transmissions of information are timed to suit transmission network traffic loads.

19. A method of transmitting information as claimed in claim 1 wherein information transmissions are sent immediately after all information required by the software has been obtained.

20. A method of transmitting information as claimed in claim 1 wherein sender identity information associated with the transmission is used to trigger additional processes run on the intended recipient's computer system.

21. A method of transmitting information as claimed in claim 20 wherein an additional process run is virus checking or security software.

22. A method of transmitting information as claimed in claim 20 wherein an additional process run forwards or copies the transmission received to a further intended recipient.

23. A method of transmitting information as claimed in claim 20 wherein an additional process supplies the received transmission to an algorithm running on the intended recipient's computer system as input to said algorithm.

24. A method of receiving information using a computer system loaded with software, said software being adapted to execute the steps of;
(i) receiving an electronic information transmission where the information transmitted includes destination information, and
(ii) storing the content of said information transmission in a destination location identified by the destination information.

25. Computer software adapted to execute a method of transmitting information through the steps of;
(i) receiving intended recipient information from a sender of information, and
(ii) receiving details from the sender of a storage location within the sender's computer system at which information to be transmitted is stored, and
(vi) transmitting all information stored within the sender's computer system at the storage location detailed by the sender to the intended recipient or recipients.

26. Computer software adapted to execute a method of transmitting information through the steps of;
(i) receiving intended recipient information from a sender of the information, and
(ii) receiving details from the sender of a storage location within a sender's computer system at which information to be transmitted is stored, and
(iii) receiving destination information from the sender indicating where the information to be transmitted is to be stored within a recipient's computer system, and
(iv) transmitting all information stored within the sender's computer system at the storage location detailed by the sender to the intended recipient or recipients.

27. Computer software adapted to execute a method of transmitting information as claimed in claim 26 further characterised by the additional subsequent step of;
(v) replicating the contents of the storage location within the sender's computer in a destination location within the recipient's computer system associated with the destination information specified by the sender.

28. Computer software adapted to execute a method of transmitting information as claimed in claim 25 wherein email or electronic mail transmission protocols used to transmit information.

29. Computer software adapted to execute a method of transmitting information as claimed in claim 25 wherein HTTP transmission protocols are used to transmit information.

30. Computer software adapted to execute a method of transmitting information as claimed in claim 25 wherein intended recipient information includes an internet address, email address and/or location information for intended recipients.

31. Computer software adapted to execute a method of transmitting information as claimed in claim 25 wherein intended recipient information includes a name or alias for an intended recipient.

32. Computer software adapted to execute a method of transmitting information as claimed in claim 25 wherein storage location information provides a reference or path to information to be transmitted.

33. Computer software adapted to execute a method of transmitting information as claimed in claim 1 wherein a storage location includes any type of electronic storage media or a portion thereof.

34. Computer software adapted to execute a method of transmitting information as claimed in claim 33 wherein a storage location is a directory formed within a hard drive incorporated into the sender's computer system.

35. Computer software adapted to execute a method of transmitting information as claimed in claim 33 wherein a storage location includes a port associated with a seideT's computer system from which information to be transmitted can be extracted by the sender's computer system.

36. Computer software adapted to execute a method of transmitting information as claimed in claim 25 wherein destination information is used to determine where information to be transmitted is to be stored in a recipient's computer system.

37. Computer software adapted to execute a method of transmitting information as claimed in claim 36 wherein destination information includes details of an explicit path or directory within a hard drive of the recipient's computer system to which received information is to be saved.

38. Computer software adapted to execute a method of transmitting information as claimed in claim 36 wherein destination information includes an alias, name or tag indicating to the recipient the nature of the information transmitted.

39. Computer software adapted to execute a method of transmitting information as claimed in claim 25 wherein received information is stored within a destination location which overwrites the existing information of content of the destination location.

40. Computer software adapted to execute a method of transmitting information as claimed in claim 39 wherein the entire content of the destination location is deleted before the received information is stored within the destination location.

41. Computer software adapted to execute a method of transmitting information as claimed in claim 39 wherein only computer files originally stored within a destination location which have the same name and/or attributes as received transmission files are overwritten.

42. Computer software adapted to execute a method of transmitting information as claimed in claim 25 wherein transmissions of information are timed to suit transmission network traffic loads.

43. Computer software adapted to execute a method of transmitting information as claimed in claim 25 wherein information transmissions are sent immediately after all information required by the software has been obtained.

44. Computer software adapted to execute a method of transmitting information as claimed in claim 25 wherein sender identity information associated with the transmission is used to trigger additional processes run on the intended recipient's computer system.

45. Computer software adapted to execute a method of transmitting information as claimed in claim 44 wherein an additional process run is virus checking or security software.

46. Computer software adapted to execute a method of transmitting information as claimed in claim 44 wherein an additional process run forwards or copies the transmission received to a further intended recipient.

47. Computer software adapted to execute a method of transmitting information as claimed in claim 44 wherein an additional process supplies the received transmission to an algorithm running on the intended recipient's computer system as input to said algorithm.

48. Computer software adapted to execute a method of receiving information through executing the steps of;
(i) receiving an electronic information transmission where the information transmitted includes destination information, and
(ii) storing the content of said information transmission in a destination location identified by the destination information.

49. A computer system loaded with software adapted to form a method of transmitting information through the steps of;
(i) receiving intended recipient information from a sender of information, and
(ii) receiving details from the sender of a storage location within the sender's computer system at which information to be transmitted is stored, and
(iii) transmitting all information stored within the sender's computer system at the storage location detailed by the sender to the intended recipient or recipients.

50. A computer system loaded with software adapted to perform a method of transmitting information through the steps of;
(i) receiving intended recipient information from a sender of the information, and
(ii) receiving details from the sender of a storage location within a sender's computer system at which information to be transmitted is stored, and
(iii) receiving destination information from the sender indicating where the information to be transmitted is to be stored within a recipient's computer system, and
(iv) transmitting all information stored within the sender's computer system at the storage location detailed by the sender to the intended recipient or recipients.

51. A computer system loaded with software as claimed in claim 50 adapted to perform a method of transmitting information further characterised by the additional subsequent step of;
(v) replicating the contents of the storage location within the sender's computer in a destination location within the recipient's computer system associated with the destination information specified by the sender.

52. A computer system loaded with software as claimed in claim 50 wherein email or electronic mail transmission protocols used to transmit information.

53. A computer system loaded with software as claimed in claim 50 wherein HTTP transmission protocols are used to transmit information.

54. A computer system loaded with software as claimed in claim 50 wherein intended recipient information includes an internet address, email address and/or location information for intended recipients.

55. A computer system loaded with software as claimed in claim 50 wherein intended recipient information includes a name or alias for an intended recipient.

56. A computer system loaded with software as claimed in claim 50 wherein storage location information provides a reference or path to information to be transmitted.

57. A computer system loaded with software as claimed in claim 50 wherein a storage location includes any type of electronic storage media or a portion thereof.

58. A computer system loaded with software as claimed in claim 56 wherein a storage location is a directory formed within a hard drive incorporated into the sender's computer system.

59. A computer system loaded with software as claimed in claim 56 wherein a storage location includes a port associated with a sender's computer system from which information to be transmitted can be extracted by the sender's computer system.

60. A computer system loaded with software as claimed in claim 50 wherein destination information is used to determine where information to be transmitted is to be stored in a recipient's computer system.

61. A computer system loaded with software as claimed in claim 60 wherein destination information includes details of an explicit path or directory within a hard drive of the recipient's computer system to which received information is to be saved.

62. A computer system loaded with software as claimed in claim 60 wherein destination information includes an alias, name or tag indicating to the recipient the nature of the information transmitted.

63. A computer system loaded with software as claimed in claim 50 wherein received information is stored within a destination location which overwrites the existing information of content of the destination location.

64. A computer system loaded with software as claimed in claim 63 where in the entire content of the destination location is deleted before the received information is stored within the destination location.

65. A computer system loaded with software as claimed in claim 63 wherein only computer files originally stored within a destination location which have the same name and/or attributes as received transmission files are overwritten.

66. A computer system loaded with software as claimed in claim 50 wherein transmissions of information are timed to suit transmission network traffic loads.

67. A computer system loaded with software as claimed in claim 50 wherein information transmissions are sent immediately after all information required by the software has been obtained.

68. A computer system loaded with software as claimed in claim 50 wherein sender identity information associated with the transmission is used to trigger additional processes run on the intended recipient's computer system.

69. A computer system loaded with software as claimed in claim 68 wherein an additional process run is virus checking or security software.

70. A computer system loaded with software as claimed in claim 68 wherein an additional process run forwards or copies the transmission received to a further intended recipient.

71. A computer system loaded with software as claimed in claim 68 wherein an additional process supplies the received transmission to an algorithm running on the intended recipient's computer system as input to said algorithm.

72. A computer system loaded with computer software adapted to execute a method of receiving information through the steps of:
(i) receiving an electronic information transmission where the information transmitted includes destination information, and
(ii) storing the content of said information transmission in a destination location identified by the destination information.
